(19) United States
(12) Patent Application Publication
(10) Pub. No.: US 2013/0100422 A1
(43) Pub. Date: Apr. 25, 2013

(54) REFLECTIVE SCREEN APPARATUS

(71) Applicants: Masashi Kitabayashi, Azumino-shi (JP); Mamoru Kobayashi, Matsumoto-shi (JP)

(72) Inventors: Masashi Kitabayashi, Azumino-shi (JP); Mamoru Kobayashi, Matsumoto-shi (JP)

(73) Assignee: SEIKO EPSON CORPORATION, Tokyo (JP)

(21) Appl. No.: 13/610,740

(22) Filed: Sep. 11, 2012

(30) Foreign Application Priority Data
Oct. 24, 2011 (JP) 2011-232550

(51) Int. Cl. G03B 21/10; G03B 21/28; G03B 21/60

(52) U.S. Cl. 353/79; 359/443; 359/449

(57) ABSTRACT

A reflective screen apparatus according to an embodiment of the invention, which is advantageous in that a reflection surface is readily formed, projection light outputted from a projector is efficiently reflected, and the convenience of a user is improved, includes a reflective screen having a reflection surface (reflection area) that reflects projection light off reflection films as reflectors selectively formed on a screen substrate in accordance with the angle of incidence of the projection light and a pair of winders that support respective ends (upper and lower ends) of the reflective screen and rotate in forward and backward directions to wind and release the reflective screen, and the winders drive each other and operate in opposite ways to move the reflection surface between the winders.

### BACKGROUND

1. Technical Field

The present invention relates to a reflective screen apparatus.

2. Related Art

There has been a known screen apparatus so configured that a screen reflects projection light projected from a projector or any other projection-type display apparatus to display an image. JP-A-2008-299219 discloses a reflective screen that displays an image projected from a projection apparatus (projector) installed in the vicinity of the screen, and the reflective screen includes a first reflection surface that receives projection light projected from a position A and reflects the projection light in substantially the same direction and a second reflection surface that receives projection light projected from a position B, which differs from the position A, and reflects the projection light in substantially the same direction.

Specifically, the first reflection surface includes a plurality of first reflection element surfaces whose inclination angle increases with distance from a predetermined point and the second reflection surface includes a plurality of second reflection element surfaces whose inclination angle increases with distance from the predetermined point with the first and second reflection element surfaces mixedly arranged. JP-A-2008-299219 states that the technology disclosed therein not only prevents brightness of the screen surface from decreasing when the angle of incidence of the projection light incident on the screen changes but also suppresses change in brightness even when the positional relationship between the projection apparatus and the screen changes.

Since the reflective screen disclosed in JP-A-2008-299219 has the first and second reflection element surfaces mixedly arranged therein, slightly different reflection surfaces are present in the vicinity of a single position, which disadvantageously requires a complicated die used to form the reflection surface. Further, since one of the first reflection surface and the second reflection surface works at a time as the reflection surface that reflects the projection light, it is difficult to reflect the projection light efficiently or a decrease in brightness or any other drawback conceivably occurs. It is further difficult to determine an appropriate position of the projection apparatus (projector) relative to the reflective screen.

It has therefore been desired to provide a reflective screen apparatus having the following advantages: The reflection surface is readily formed; projection light outputted from a projector is efficiently reflected; and the convenience of a user is improved.

### SUMMARY

An advantage of some aspects of the invention is to solve at least a part of the problems described above, and the invention can be implemented as the following forms or application examples.

### Application Example 1

A reflective screen apparatus according to this application example includes a reflective screen having a reflection surface that reflects projection light off reflectors selectively formed on a screen substrate in accordance with the angle of incidence of the projection light and a pair of winders that support respective ends of the reflective screen and rotate in forward and backward directions to wind and release the reflective screen, and the winders drive each other and operate in opposite ways to move the reflection surface between the winders.

According to the thus configured reflective screen apparatus, the reflection surface of the reflective screen has reflectors selectively formed on the screen substrate in accordance with the angle of incidence of the projection light, whereby different reflection surfaces do not coexist and the reflection surface is therefore readily formed. Further, since the reflection surface can be moved by operating the winders (winding and releasing operation) to display a desired reflection surface, the convenience provided by the reflective screen apparatus can be improved and the size thereof can be reduced.

### Application Example 2

In the reflective screen apparatus according to the above application example, it is preferable that the reflective screen apparatus further includes a distance indicator that exposes a projection distance that corresponds to the reflection surface and is associated with a projector that outputs the projection light.

According to the thus configured reflective screen apparatus, which includes the distance indicator that exposes the projection distance associated with the projector, the position where the projector is installed (projection distance) relative to the reflective screen whose reflection surface is moved by the operation of the winders is presented, whereby the projector can be readily installed in a projection position corresponding to the reflection surface. The projector can therefore be installed at an appropriate projection distance in correspondence with a desired reflection surface, whereby the projection light can be efficiently reflected.

### Application Example 3

In the reflective screen apparatus according to the above application example, it is preferable that the distance indicator is formed on the screen substrate.

According to the thus configured reflective screen apparatus, in which the distance indicator is formed on the screen substrate, when the reflection surface is moved by operating the winders, an appropriate projection distance can be displayed in correspondence with the reflection surface having been moved and displayed, whereby the reflection surface can be readily related to the projection distance. As a result, the projector can be installed in an appropriate position (projection distance) in correspondence with the reflection surface of the reflective screen.

### Application Example 4

In the reflective screen apparatus according to the above application example, it is preferable that the reflective screen apparatus further includes a holder that holds the winders, a mount on which a projector that outputs the projection light is mounted, and a base that supports the holder and the mount.

According to the thus configured reflective screen apparatus, which includes the holder, the mount, and the base, the projector can be readily installed, whereby the convenience provided by the reflective screen apparatus is improved.

### Application Example 5

In the reflective screen apparatus according to the above application example, it is preferable that the reflective screen apparatus further includes a drive unit that is driven by the rotation of the winders to move the mount to a predetermined position corresponding to the projection distance.

According to the thus configured reflective screen apparatus, which includes the drive unit, the mount is moved to a position at a predetermined projection distance in correspondence with the reflection surface of the reflective screen. The projector can therefore be more readily installed in a position at the predetermined projection distance, whereby the convenience provided by the reflective screen apparatus is further improved.

### Application Example 6

In the reflective screen apparatus according to the above application example, it is preferable that the reflective screen apparatus further includes a first reflector that reflects and projects the projection light on the reflection surface.

According to the thus configured reflective screen apparatus, which includes the first reflector, the projector can be installed in the vicinity of the reflective screen.

### Application Example 7

In the reflective screen apparatus according to the above application example, it is preferable that the first reflector is foldably disposed.

According to the thus configured reflective screen apparatus, the first reflector is folded not to interfere with anything when the first reflector is not in use, whereby the convenience provided by the reflective screen apparatus is further improved.

### Application Example 8

In the reflective screen apparatus according to the above application example, it is preferable that the reflective screen apparatus further includes an angle indicator that exposes a projection angle that corresponds to the reflection surface and is associated with a projector that outputs the projection light.

According to the thus configured reflective screen apparatus, which includes the angle indicator that exposes the projection angle associated with the projector, the position where the projector is installed (projection angle) relative to the reflective screen whose reflection surface is moved by the operation of the winders is presented, whereby the projector can be installed at a projection angle corresponding to the reflection surface.

### Application Example 9

In the reflective screen apparatus according to the above application example, it is preferable that the angle indicator is formed on the screen substrate.

According to the thus configured reflective screen apparatus, in which the angle indicator is formed on the screen substrate, when the reflection surface is moved by operating the winders, the projection angle formed on the screen substrate on which the displayed reflection surface is formed can be checked, whereby the reflection surface can be readily related to the projection angle. As a result, the projector can be installed in an appropriate position (projection angle) in correspondence with the reflection surface of the reflective screen.

### Application Example 10

In the reflective screen apparatus according to the above application example, it is preferable that the reflective screen apparatus further includes a holder that holds the winders, an expander/contractor that moves the holder to a predetermined height, amount on which a projector that outputs the projection light is mounted and which changes a projection angle of the projector, and a base that supports the expander/contractor and the mount.

According to the thus configured reflective screen apparatus, which includes the holder, the expander/contractor, the mount and the base, the projector can be readily installed in the reflective screen apparatus in a stable manner, whereby the convenience provided by the reflective screen apparatus is improved.

### Application Example 11

In the reflective screen apparatus according to the above application example, it is preferable that the reflective screen apparatus further includes a drive unit that is driven by the rotation of the winders or the expansion/contraction of the expander/contractor to not only expand/contract the expander/contractor or rotate the winders but also rotate the mount to a predetermined position corresponding to the projection angle.

According to the thus configured reflective screen apparatus, which includes the drive unit, driven by the rotation of the winders, the expander/contractor expands/contracts and the mount is rotated to a predetermined projection angle. Alternatively, driven by the expansion/contraction of the expander/contractor, the winders are rotated and the mount is rotated to a predetermined projection angle. As a result, the projector can be more readily installed at the predetermined projection angle, whereby the convenience provided by the reflective screen apparatus is further improved.

### Application Example 12

In the reflective screen apparatus according to the above application example, it is preferable that the reflective screen apparatus further includes a holder that holds the winders, an expander/contractor that moves the holder to a predetermined height, a second reflector that changes the angle of reflection in correspondence with the projection angle to reflect and project the projection light on the reflection surface, and a base that supports the expander/contractor.

According to the thus configured reflective screen apparatus, which includes the holder, the expander/contractor, the second reflector, and the base, the angle of reflection is changed in correspondence with the projection angle and the projection light then is projected on the reflective screen, whereby the convenience provided by the reflective screen apparatus is improved.

### Application Example 13

In the reflective screen apparatus according to the above application example, it is preferable that the reflective screen apparatus further includes a drive unit that is driven by the rotation of the winders or the expansion/contraction of the expander/contractor to not only expand/contract the expander/contractor or rotate the winders but also rotate the second reflector to a predetermined position corresponding to the angle of reflection.

According to the thus configured reflective screen apparatus, which includes the drive unit, driven by the rotation of the winders, the expander/contractor expands/contracts and the second reflector is rotated to a predetermined angle of reflection. Alternatively, driven by the expansion/contraction of the expander/contractor, the winders are rotated and the second reflector is rotated to a predetermined angle of reflection. As a result, the projector can be more readily rotated to a predetermined angle of reflection, whereby the convenience provided by the reflective screen apparatus is further improved.

### BRIEF DESCRIPTION OF THE DRAWINGS

The invention will be described with reference to the accompanying drawings, wherein like numbers reference like elements.

FIG. 1 is a side view diagrammatically showing a reflective screen apparatus according to a first embodiment.

FIG. 2 diagrammatically shows the front surface of a reflective screen.

FIGS. 3A and 3B diagrammatically show not only cross sections of the reflective screen but also a procedure of manufacturing the reflective screen.

FIG. 4 is a plan view of the reflective screen and winders viewed in the direction directly facing them.

FIG. 5 is a side view diagrammatically showing a reflective screen apparatus according to a second embodiment.

FIG. 6 diagrammatically shows the front surface of a reflective screen.

FIG. 7 is a plan view of the reflective screen and winders viewed in the direction directly facing them.

FIGS. 8A and 8B are side views showing a variation of the first embodiment using a first reflector.

FIG. 9 is a side view showing a variation of the second embodiment using a second reflector.

### DESCRIPTION OF EXEMPLARY EMBODIMENTS

Embodiments will be described below with reference to the drawings.

### First Embodiment

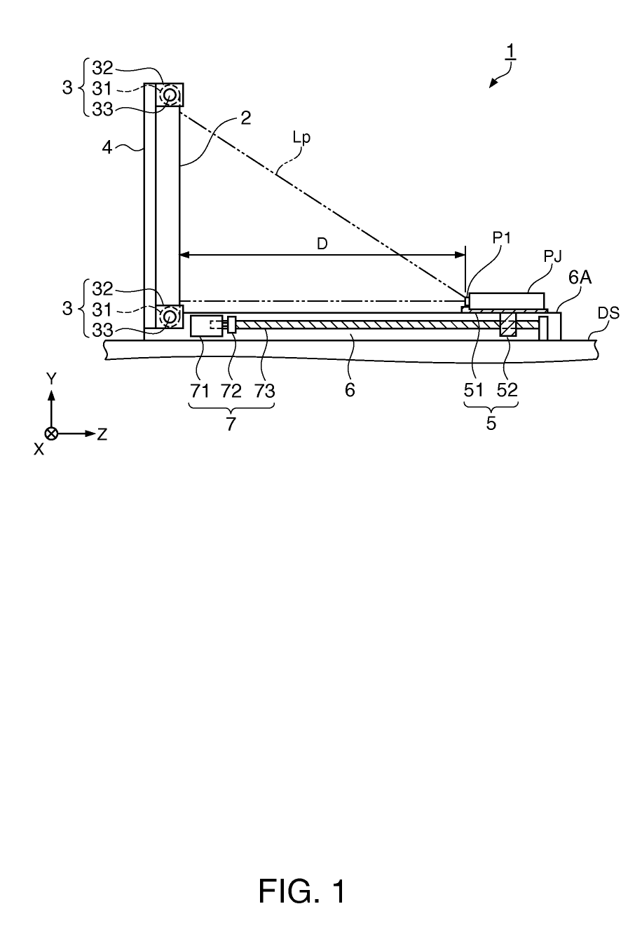

FIG. 1 is a side view diagrammatically showing a reflective screen apparatus 1 according to a first embodiment. FIG. 1 also shows a schematic cross section of the screen apparatus 1. The configuration of the reflective screen apparatus 1 according to the present embodiment will be described with reference to FIG. 1.

The reflective screen apparatus 1 according to the present embodiment is installed on a desk surface DS or any other suitable surface, and a mount 5 on which a projector PJ is mounted is so moved to a predetermined position (position determined by projection distance D) that the projection light Lp outputted from the projector PJ is reflected on the reflective screen 2.

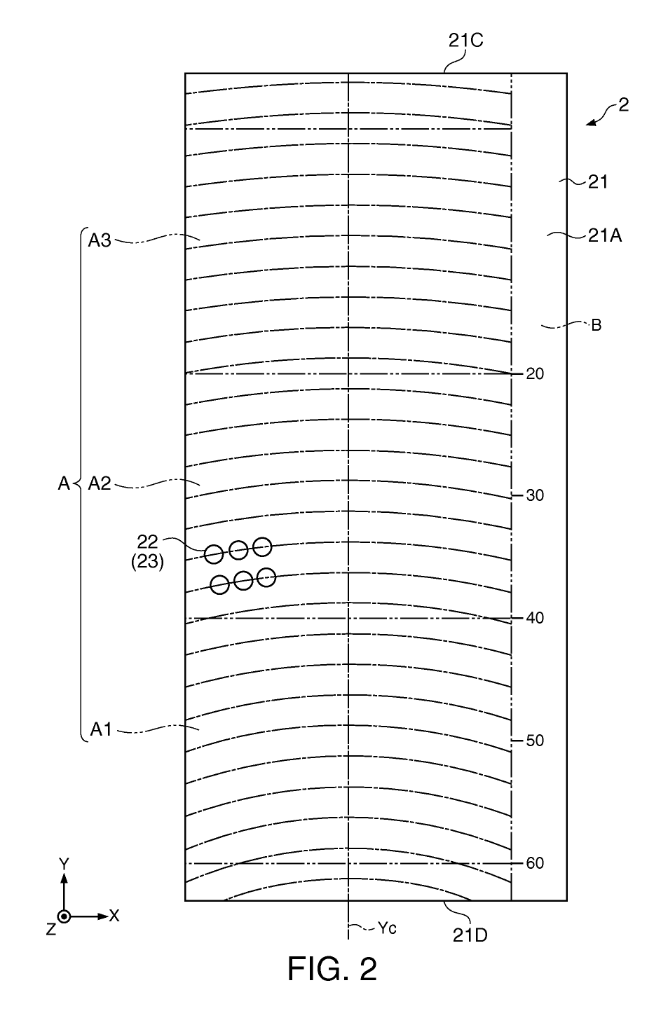

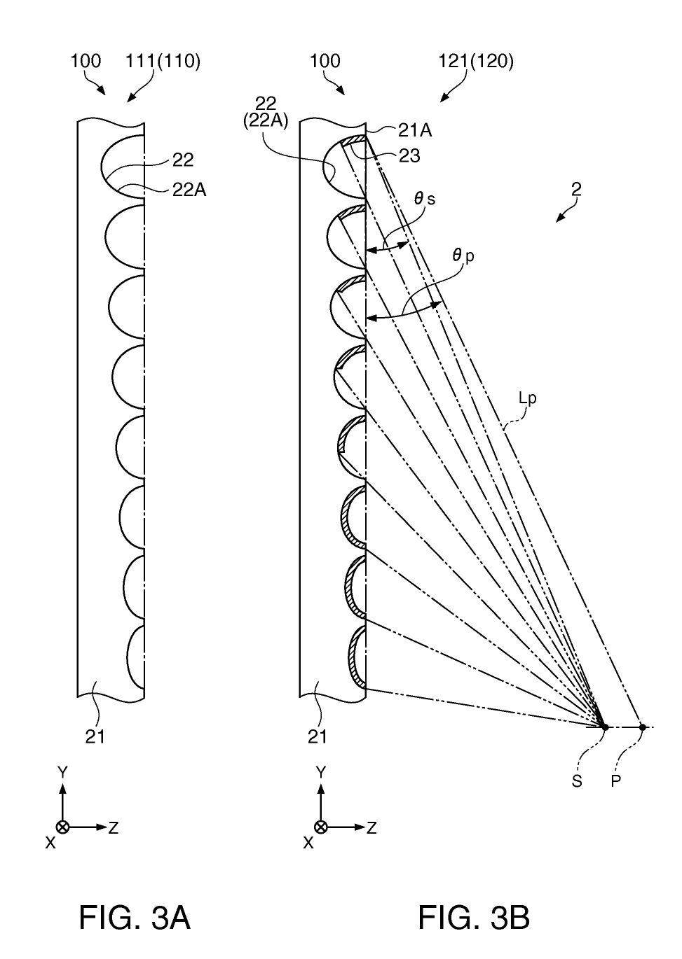

The reflective screen apparatus 1 includes a reflective screen 2 having a reflection surface that reflects the projection light Lp outputted from the projector PJ and a pair of winders 3 that rotate in forward and backward directions to wind and release the reflective screen 2. The reflective screen apparatus 1 further includes a holder 4 that holds the winders 3 and a base 6 that holds not only the holder 4 but also the mount 5 on which the projector PJ is mounted. The reflective screen apparatus 1 still further includes a drive unit 7 that is driven by the rotation of the winders 3 to move the mount 5 to a predetermined position (position determined by projection distance D). The reflection surface used in the present embodiment refers to a reflection area A in which recesses 22, each of which includes a reflection film 23, which will be described later (see FIGS. 2, 3A, and 3B for the recesses 22, reflection films 23, and reflection area A), are formed.

In the reflective screen apparatus 1, the reflective screen 2 stands in a direction substantially perpendicular to the base 6. Further, in the reflective screen apparatus 1, the holder 4 and the winders 3 fix the vertical distance of the reflection surface (reflection area A), which will be described later, of the reflective screen 2.

In the following description, the reflective screen apparatus 1 and the reflective screen 2 are abbreviated to a screen apparatus 1 and a screen 2, respectively, which are used as appropriate.

In the following figures including FIG. 1, the dimensions of each component and ratios associated therewith differ from actual values as appropriate in order to enlarge the component to a recognizable size in the drawings. Further, in the following figures including FIG. 1, an XYZ Cartesian coordinate system is used for the convenience of description. In the XYZ Cartesian coordinate system, let the Y direction be perpendicular to the desk surface DS (+Y direction extends toward the screen 2 that stands on the desk surface DS). Let the X direction be parallel to the reflection surface of the standing screen 2 and perpendicular to the Y direction (+X direction extends rightward when viewed in the direction directly facing the reflection surface of the standing screen 2). Let the Z direction be perpendicular to the Y and X directions (+Z direction directly faces the reflection surface of the standing screen 2). Further, with reference to the gravitational direction, let a downward direction be the gravitational direction and an upward direction be the direction opposite the gravitational direction.

FIG. 2 diagrammatically shows a front surface 21A of the reflective screen 2 and a plan view showing the entire reflective screen 2. FIGS. 3A and 3B diagrammatically show not only cross sections of the reflective screen 2 but also a procedure 100 of manufacturing the reflective screen 2, with FIG. 3A diagrammatically showing a substrate deformation step 110 and FIG. 3B diagrammatically showing a reflection film formation step 120. FIGS. 3A and 3B diagrammatically show cross sections of the screen 2 taken along the Y direction. The configuration of the screen 2 will be described with reference to FIG. 2. The procedure of manufacturing the screen 2 will be described with reference to FIGS. 3A and 3B.

The screen 2 has an external shape so configured that the vertical length (in Y direction) is longer than the horizontal length (in X direction), as shown in FIG. 2. The reason for this is that the screen apparatus 1 according to the present embodiment is configured as an apparatus using a compact projector PJ. In the present embodiment, the compact projector PJ is assumed to have a plan-view size of about a postcard.

The front surface 21A of the screen 2 is formed of a reflection area A as the reflection surface formed of the recesses 22 on which the reflection films 23, which will be described later, are selectively formed and a distance indicator B showing an appropriate projection distance D (see FIG. 1) from the projector PJ that corresponds to the reflection area A, as shown in FIG. 2.

The recesses 22 are so formed that they are arranged along arcs around a predetermined position on a central line Yc in the X direction of the reflection area A and arranged concentrically around the predetermined position in the Y direction. The recesses 22 in the present embodiment each have a substantially hemispherical shape and are arranged at intervals of about 300 μm.

The reflective screen 2 of the present embodiment is formed of a flexible substrate having a sheet-like shape (hereinafter referred to as screen substrate 21). The screen substrate 21 is made of a black polyvinyl chloride resin in the present embodiment. The reason why a black resin is used is that it tends to absorb unwanted incident light.

The manufacturing procedure 100 of forming the recesses 22 and the reflection films 23 of the screen 2 includes the substrate deformation step 110 and the reflection film formation step 120, as shown in FIGS. 3A and 3B. In the manufacturing procedure 100, the substrate deformation step 110 is first carried out and then the reflection film formation step 120 is carried out.

The substrate deformation step 110 is a step of deforming the screen substrate 21, as shown in FIG. 3A. The substrate deformation step 110 includes a transfer step 111 in the present embodiment. In the transfer step 111, the screen substrate 21 is so deformed that a plurality of recesses 22 are formed in the front surface 21A of the screen substrate 21. The transfer step 111 is carried out by using an embossing apparatus (not shown) as a transfer apparatus that heats and presses a die against the screen substrate 21.

The embossing apparatus forms a necessary shape by heating a die having a reversed shape of a shape to be formed and pressing the die against the screen substrate 21 in the front-rear direction thereof (Z direction) with a high pressure to thermally deform (transfer) the screen substrate 21 along the shape of the die. The recesses 22 are thus formed, as shown in FIG. 3A. Each of the recesses 22 in the present embodiment has a substantially hemispherical shape, as described above.

Further, the recesses 22 are formed to have respective inner surface 22A whose depth gradually increases from a lower end 21D to an upper end 21C of the screen 2 (see FIG. 2), as shown in FIGS. 3A and 3B. The reason for this is that the thus formed reflection films 23, which will be described later, can efficiently reflect light projected from the projector PJ in the horizontal direction toward a viewer (+Z direction) under the condition that the angle of the projection light becomes steep with distance from the lower end of the screen.

After the substrate deformation step 110 is finished, the reflection film formation step 120 is carried out. The reflection film formation step 120 is a step of selectively forming the reflection films 23 on the inner surfaces 22A of the recesses 22, as shown in FIG. 3B. The reflection film formation step 120 includes a vapor deposition step 121 in the present embodiment. In the present embodiment, an aluminum film is selectively formed on each of the inner surfaces 22A in the vapor deposition step 121.

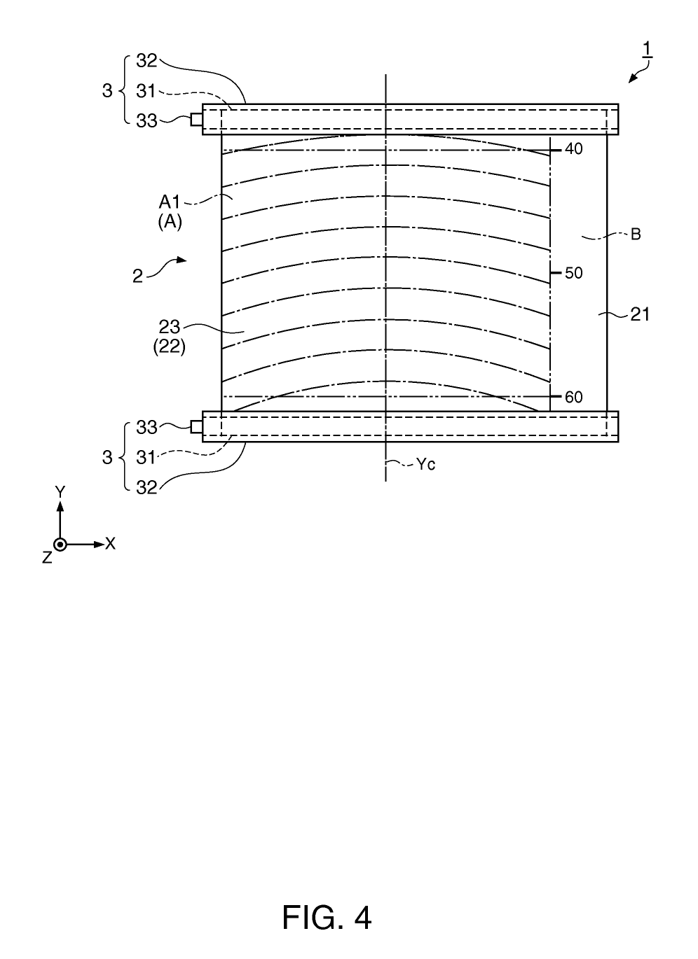

In the vapor deposition step 121, a vapor deposition source S is disposed on the central line Yc shown in FIG. 4 on the side where the lower end 21D of the screen substrate 21 shown in FIG. 2 is present, as shown in FIG. 3B. In detail, in the vapor deposition step 121, before the reflection films 23 are formed, the position of the projector PJ that outputs the projection light Lp obliquely toward the front surface 21A is determined in advance as a virtual light source position P. The vapor deposition source S is then so disposed that a vapor deposition angle θs at which a vapor deposition material is deposited on each of the recesses 22 in the front surface 21A is equal to or smaller than the angle of incidence θp of the projection light Lp from the virtual light source position P with respect to each of the recesses 22 in the front surface 21A, and the vapor deposition material is then deposited on each of the recesses 22 in the direction in which the projection light Lp is incident.

After the vapor deposition step 121 is carried out, a concave reflection film 23 is formed along the inner surface 22A of each of the recesses 22 on which the projection light Lp is incident. The oblique vapor deposition described above allows the reflection films 23 to be formed on the recesses 22 in the front surface 21A selectively and radially around the vapor deposition source S.

FIG. 4 is a plan view of the reflective screen 2 and the winders 3 viewed in the direction directly facing them. The configurations of the reflective screen 2 and the winders 3 will be described with reference to FIG. 4.

Each of the winders 3 of the present embodiment includes a winder body 31 that supports and fixes the upper end 21C or the lower end 21D of the screen 2 and has a rotary shaft having substantially the same length as the width of the screen 2 (in X direction) to wind the screen 2. The winder body 31 has a spring member (not shown) that always exerts a tension in the direction in which the screen 2 is wound. Each of the winders 3 further includes a winder frame 32 that covers the winder body 31, and a dial 33 that rotates the winder body 31 is disposed on the left side surface of the winder frame 32.

The vertical position (range) (in Y direction) of the screen 2 is fixed because the holder 4 fixes the positions of the winders 3. Since the winders 3 are thus fixed, and the spring members, each of which always exerts a tension in the direction in which the screen 2 is wound, always pull the screen 2 sandwiched between the pair of winders 3, the amount of sag of the screen 2 is reduced.

The winders 3 (winder bodies 31) rotate in forward and backward directions to wind and release the screen 2 when the dials 33 are rotated. When one of the dials 33 is rotated, the other dial 33 is driven and rotated to operate in reverse. In detail, the winder bodies 31 are so configured that when the upper dial 33 is rotated to release the screen 2, the lower dial 33 is driven and rotated to wind the screen 2. The winder bodies 31 are also so configured that when the upper dial 33 is rotated to wind the screen 2, the lower dial 33 is driven and rotated to release the screen 2.

The reflection surface (reflection area A) between the winders 3 can be moved with the screen 2 always pulled by the operation of the winder bodies 31. In FIG. 4, a reflection area A1, which is a lower portion of the entire reflection area A of the screen 2 (see FIG. 2), is displayed (exposed) as the reflection surface.

Referring back to FIG. 2, in the present embodiment, the reflection area A is formed of the following three reflection areas, one of which is selected in accordance with the projection distance D from the projector PJ: a reflection area A1 for long distance, which is preferable for long-distance projection (about 60 cm in the present embodiment); a reflection area A2 for middle distance, which is preferable for mid-distance projection (about 40 cm in the present embodiment); and a reflection area A3 for near distance, which is preferable for near-distance projection (about 20 cm in the present embodiment). It is, however, noted that the reflection area A is not fixed but can be so moved by rotating the dials 33 of the winders 3 that a desired reflection area A is displayed for use.

Further, the distance indicator B, which exposes (displays) the projection distance D corresponding to the reflection surface, is formed in a right area of the front surface 21A of the screen 2 (screen substrate 21) (area to the right of the reflection area A), as shown in FIG. 2. In the present embodiment, the distance indicator B is the projection distance D printed on the front surface 21A. When the reflection area A is so moved by rotating the dials 33 of the winders 3 that an arbitrary portion of the reflection area A is displayed, the projection distance D corresponding to the displayed reflection area A is also displayed.

Referring back to FIG. 4, when the screen 2 is so moved that the reflection area A1 is displayed, the projection distance D is displayed as the distance indicator B described above in the right area of the front surface 21A of the screen 2. In detail, FIG. 4 shows 40 cm, 50 cm, and 60 cm as the projection distance D. In this case, the projection distance D displayed in the lowest portion is an appropriate projection distance D for the displayed reflection area A. In this case, the appropriate projection distance D is 60 cm. In the screen apparatus 1 according to the present embodiment, the mount 5 is driven by the rotation of the dials 33 and moved to the appropriate projection distance D. In the example shown in FIG. 4, the mount 5 is moved to a position where the projection distance D from the screen 2 is 60 cm.

The configuration and operation of the screen apparatus 1 will be described with reference to FIG. 1.

The drive unit 7 is disposed in the base 6 and driven by the rotation of the winders 3 to move the mount 5 to a predetermined position (position determined by projection distance D). The drive unit 7 includes a motor 71 rotatable in forward and backward directions, a transmission gear 72 that transmits the rotation of the motor 71, and a rod-shaped gear 73 that engages with the transmission gear 72 and extends in the Z direction.

The drive unit 7 further includes an encoder (not shown) that detects the amount of rotation of the dials 33 of the winders 3 and a driver (not shown) that rotates the motor 71 in accordance with a detection result from the encoder. The drive unit 7 still further includes a controller (not shown) that controls drive operation of the drive unit 7 including the encoder and the driver.

The mount 5 includes a mount body 51 that slides in the Z direction along an upper surface 6A of the base 6 and a support 52 that supports the mount body 51 and engages with the rod-shaped gear 73 in the drive unit 7. The support 52 is shaped in correspondence with the shape of the rod-shaped gear 73 and translates while engaging with the rod-shaped gear 73. The projector PJ is mounted on the mount body 51.

In the screen apparatus 1, when the dials 33 are rotated, the encoder detects the amount of rotation of the dials 33 and sends the controller a signal carrying a detection result. The controller sends the driver a signal corresponding to the signal from the encoder. The driver rotates the motor 71 to move the mount 5 in response to the signal from the controller by a predetermined amount corresponding to the rotation of the dials 33. The transmission gear 72 transmits the rotation of the motor 71 to the rod-shaped gear 73, which is then rotated.

The rotation of the rod-shaped gear 73 allows the support 52, which is part of the mount 5 and engages with the rod-shaped gear 73, to translate along the rod-shaped gear 73 and stop in a position corresponding to a predetermined projection distance D. When the support 52 translates, the mount body 51 also moves along the upper surface 6A of the base 6 and stops in the position corresponding to the predetermined projection distance D.

The projector PJ is then so operated to make an adjustment that the projection light Lp is projected within the display range of the screen 2. In this way, the projector PJ can be located for projection in a position at an appropriate projection distance D corresponding to the reflection surface (reflection area A) displayed in accordance with the rotation of the winders 3. In other words, the screen 2, specifically, the reflection surface (reflection area A) corresponding to the projection distance D, reflects the projection light Lp from the projector PJ toward a viewer without any decrease in contrast.

The embodiment described above provides the following advantageous effects.

The reflective screen apparatus 1 according to the present embodiment includes the reflective screen 2 having the reflection surface (reflection area A) that reflects the projection light Lp off the reflection films 23 selectively formed on the screen substrate 21 in accordance with the angle of incidence θp of the projection light Lp. The reflective screen apparatus 1 further includes a pair of winders 3 that support the upper end 21C and the lower end 21D of the reflective screen 2 and rotate in forward and backward directions to wind and release the reflective screen 2. The winders 3 drive each other and operate in opposite ways to move the reflection surface between the winders 3. The configuration described above allows the reflection surface (reflection area A) of the reflective screen 2 to be readily formed by selectively and continuously forming the reflection films 23 on the screen substrate 21 in accordance with the angle of incidence θp of the projection light Lp, unlike related art in which different reflection surfaces coexist. Further, since the reflection surface (reflection area A) can be moved by operating the winders 3 (winding and releasing operation) to display a desired reflection area, the convenience provided by the reflective screen apparatus 1 can be improved and the size thereof can be reduced.

According to the reflective screen apparatus 1 of the present embodiment, which includes the drive unit 7, the projector PJ can be readily moved to a position at a predetermined projection distance D when the winders 3 are rotated to display a desired reflection surface, whereby the projection light Lp can be efficiently reflected and the performance in contrast can be maintained. Further, providing the thus configured drive unit 7 improves the convenience provided by the reflective screen apparatus 1.

According to the reflective screen apparatus 1 of the present embodiment, which includes the holder 4, the mount 5, and the base 6, the projector PJ can be stably and readily installed, whereby the convenience provided by the reflective screen apparatus 1 is improved.

### Second Embodiment

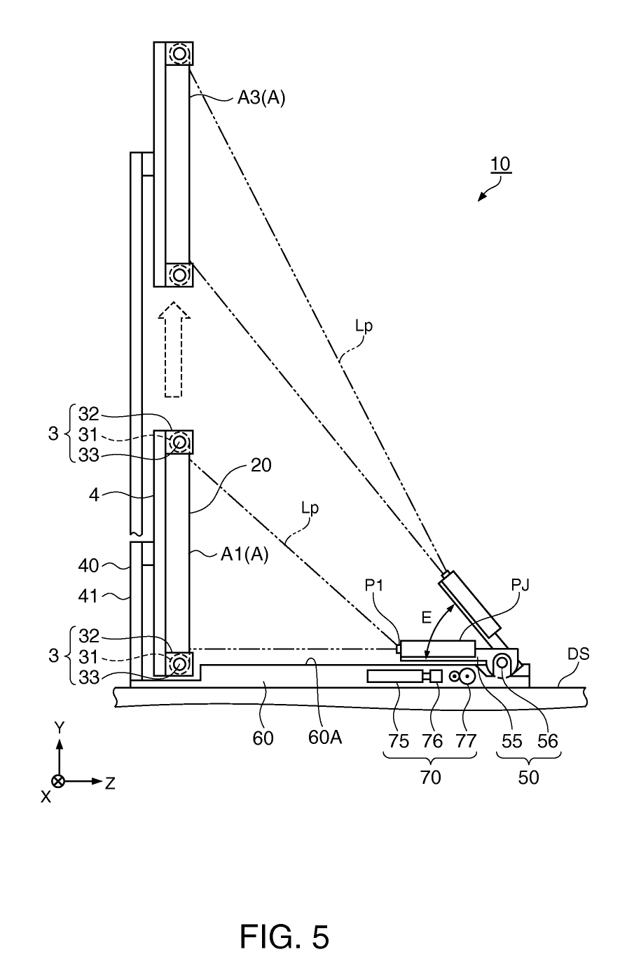

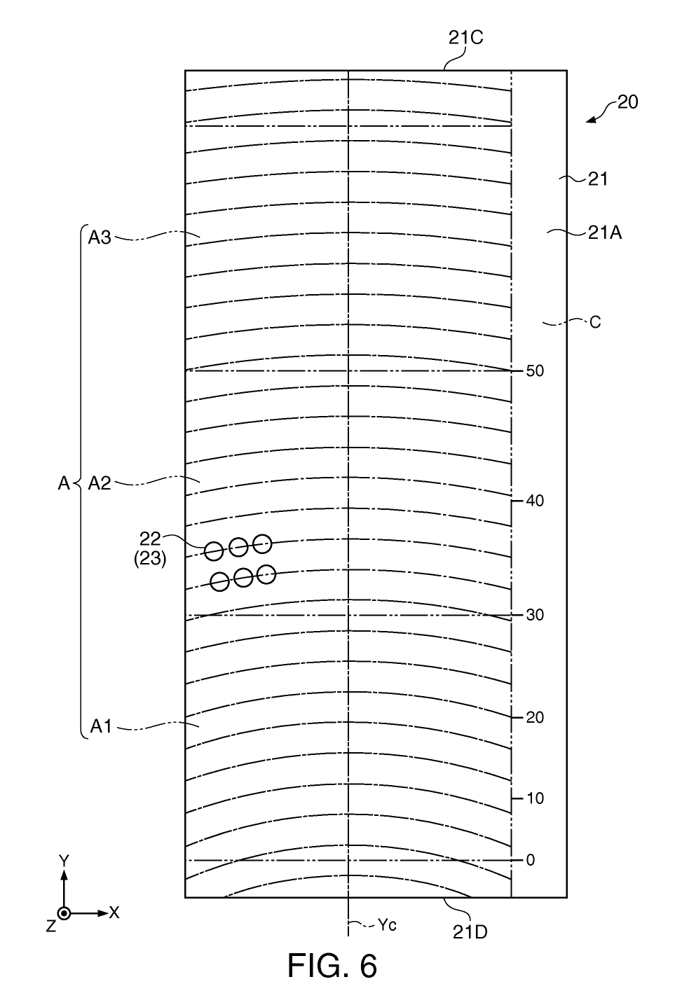

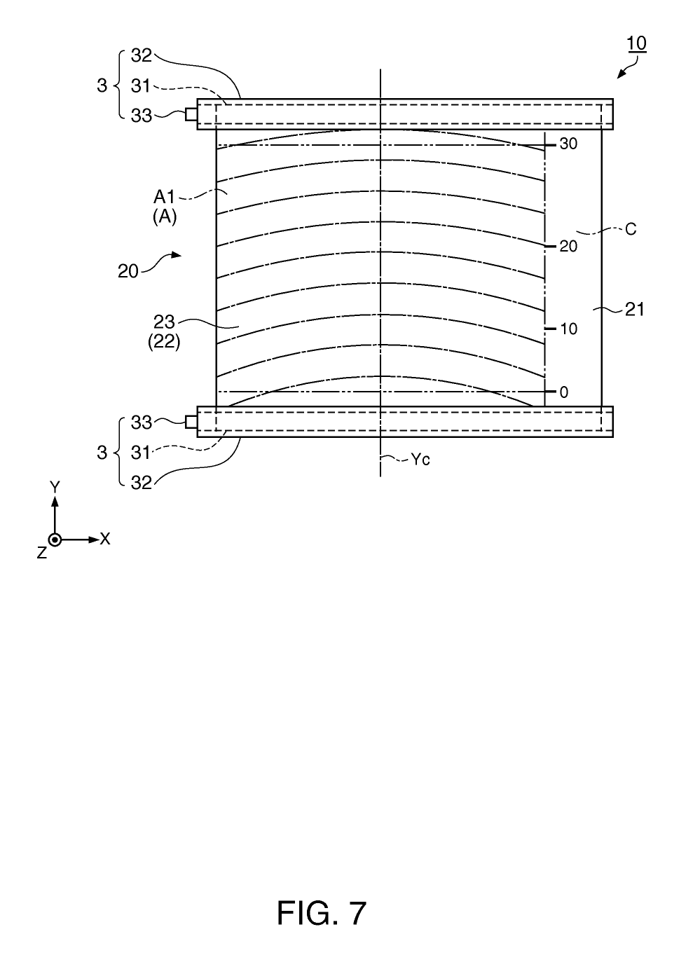

FIG. 5 is a side view diagrammatically showing a reflective screen apparatus 10 according to a second embodiment. FIG. 6 diagrammatically shows a front surface 21A of a reflective screen 20. FIG. 7 is a plan view of the reflective screen 20 and the winders 3 viewed in the direction directly facing them. FIG. 5 simultaneously shows a case where A1 is displayed and a case where A3 is displayed as the reflection area A of the screen 20. The configuration and operation of the reflective screen apparatus 10 according to the present embodiment will be described with reference to FIGS. 5 to 7.

The screen apparatus 10 of the present embodiment differs from that of the first embodiment in that the reflective screen apparatus 10 includes an expander/contractor 40 that moves the holder 4 to a predetermined height, a mount 50 on which the projector PJ that outputs projection light Lp is mounted and which changes a projection angle E of the projector PJ, and a base 60 that supports the expander/contractor 40 and the mount 50. The screen apparatus 10 also differs from that of the first embodiment in that the screen apparatus 10 further includes a drive unit 70 that not only expands/contracts the expander/contractor 40 to move the holder 4 to a predetermined height but also rotates the mount 50, which will be described later, to a predetermined projection angle E when the winders 3 are rotated. The other components are the same as those in the first embodiment.

The screen 20 of the present embodiment is so configured as shown in FIG. 6 that the reflection area A is formed as the reflection surface, which is formed of the recesses 22 where the reflection films 23 are selectively formed, in a left area of the front surface 21A of the screen 20, as in the first embodiment. The present embodiment differs from the first embodiment in that an angle indicator C that shows an appropriate projection angle E (see FIG. 5) of the projector PJ that corresponds to the reflection area A is formed in a right area of the front surface 21A of the screen 20 (screen substrate 21).

The winders 3 of the present embodiment are configured in the same manner as those of the first embodiment, as shown in FIG. 7. Further, the winders 3 (winder bodies 31) operate in the same manner as in the first embodiment. In FIG. 7, the reflection area A1, which is a lower portion of the entire reflection area A of the screen 20 (see FIG. 6), is displayed (exposed) as the reflection surface.

Referring back to FIG. 6, in the present embodiment, the reflection area A is formed of the following three reflection areas, one of which is selected in accordance with the projection angle E of the projector PJ: a reflection area A1, which is preferable for a projection angle E of about 0°; a reflection area A2, which is preferable for a projection angle E of about 30°; and a reflection area A3, which is preferable for a projection angle E of about 50°. It is, however, noted that the reflection area A is not fixed but can be so moved by rotating the dials 33 of the winders 3 that an arbitrary portion of the reflection area A is displayed for use.

The projection angle E is printed as the angle indicator C on the front surface 21A of the screen 20, as shown in FIG. 6. In other words, when the reflection area A is so moved by rotating the dials 33 of the winders 3 that an arbitrary portion of the reflection area A is displayed, the projection angle E corresponding to the displayed reflection area A is displayed, as shown in FIG. 7.

When the screen 20 is so moved that the reflection area A1 is displayed, the projection angle E is displayed as the angle indicator C described above in a right area of the front surface 21A of the screen 20, as shown in FIG. 7. In detail, 0°, 10°, 20°, and 30° are displayed as the projection angle E in FIG. 7. In this case, the projection angle E displayed in the lowest portion is an appropriate projection angle E for the displayed reflection area A. In this case, the appropriate projection angle E is 0°. In the screen apparatus 10 according to the present embodiment, when the drive unit 70 is driven by the rotation of the dials 33, the expander/contractor 40 expands/contracts to move the screen 20 (including winders 3 and holder 4) to a height corresponding to the reflection area A, and the mount 50 is rotated to an appropriate projection angle E. In FIG. 7, the mount 50 is rotated to the projection angle E of 0°.

The configuration and operation of the screen apparatus 10 will be described with reference to FIG. 5.

The drive unit 70, when driven by the rotation of the winders 3, expands/contracts the expander/contractor 40 to move the screen 20 (including winders 3 and holder 4) to a height corresponding to the reflection area A. The expander/contractor 40 includes an air cylinder (not shown), and the exterior of the expander/contractor 40 is covered with an expanding/contracting housing 41. The drive unit 70 is disposed in the base 60. The drive unit 70 includes a motor 75 rotatable in forward and backward directions, a transfer gear 76 disposed in association with the motor 75, and a reduction gear train 77 that engages with the transfer gear 76 and engages with a support shaft 56 of the mount 50.

The drive unit 70 further includes an encoder (not shown) that detects the amount of rotation of the dials 33 of the winders 3, an air cylinder driver (not shown) that expands/contracts the air cylinder based on a detection result from the encoder, and a motor driver (not shown) that rotates the motor 75. The drive unit 70 still further includes a controller (not shown) that controls drive operation of the drive unit 70 including the encoder and the driver.

The mount 50 includes a mount body 55 on which the projector PJ is mounted and a support shaft 56 that supports the mount body 55 and engages with a final gear (not shown) of the reduction gear train 77 in the drive unit 70. The support shaft 56, which engages with the final gear, rotates the mount body 55 to change the angle of the mount body 55 with respect to an upper surface 60A of the base 60.

In the screen apparatus 10, when the dials 33 are rotated, the encoder detects the amount of rotation of the dials 33 and sends a signal carrying a detection result to the controller. The controller sends a signal corresponding to the signal from the encoder to the air cylinder driver. The air cylinder driver instructs the air cylinder to expand/contract in response to the signal from the controller by a predetermined amount corresponding to the rotation of the dials 33. The expanding/contracting housing 41 also expands/contracts accordingly.

The controller further sends a signal corresponding to the signal from the encoder to the driver for the motor 75. The driver for the motor 75 rotates the motor 75 in response to the signal from the controller. The transfer gear 76 transfers the rotation of the motor 75 to the reduction gear train 77.

The rotation of the reduction gear train 77 allows the support shaft 56, which is part of the mount 50 and engages with the final gear of the reduction gear train 77, to rotate and stop at a predetermined projection angle E. When the support shaft 56 rotates, the mount body 55 also rotates around the support shaft 56 and stops at the predetermined projection angle E.

The projector PJ is then so operated to make an adjustment that the projection light Lp is projected within the display range of the screen 20. The projector PJ can thus be located in a position at the appropriate projection angle E corresponding to the reflection area (reflection area A) displayed in accordance with the rotation of the winders 3. In other words, the screen 20, specifically, the reflection surface (reflection area A) corresponding to the projection angle E, reflects the projection light Lp from the projector PJ toward a viewer without any decrease in the contrast.

The embodiment described above provides not only the same advantageous effects provided by the first embodiment but also the following advantageous effects.

According to the reflective screen apparatus 10 of the present embodiment, which includes the expander/contractor 40 and the drive unit 70, when the winders 3 are rotated to display a desired reflection surface, the screen 20 can be moved to a predetermined height and the projector PJ can be readily rotated to a predetermined projection angle E, whereby the projection light Lp can be efficiently reflected and the performance in contrast can be maintained. Further, providing the expander/contractor 40 and the drive unit 70 described above improves the convenience provided by the reflective screen apparatus 10.

According to the reflective screen apparatus 10 of the present embodiment, which includes the holder 4, the expander/contractor 40, the mount 50 and the base 60, the projector PJ can be stably and readily installed, whereby the convenience provided by the reflective screen apparatus 10 is improved.

The invention is not limited to the first and second embodiments described above, and a variety of changes, improvements, and other modifications can be made thereto to the extent that they do not depart from the substance of the invention. Variations of the first and second embodiments will be described below.

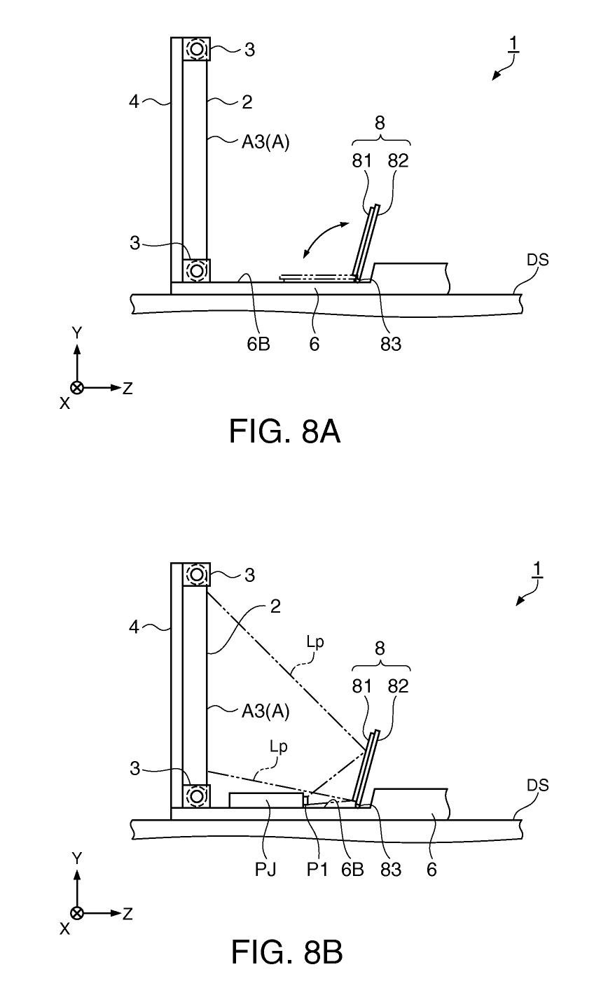

In the reflective screen apparatus 1 of the first embodiment described above, a projection lens P1 of the projector PJ faces the reflection surface for projection even in near-distance (about 20 cm) projection, but the projection lens P1 does not necessarily face the reflection surface. Alternatively, a first reflector 8 (see FIGS. 8A and 8B) may be used to perform projection. In the following section, a description will be made on the configuration and operation of the first reflector 8 and how to allow the reflective screen apparatus 1 using the first reflector 8 to perform near-distance projection.

FIGS. 8A and 8B are side views showing a variation of the first embodiment using the first reflector 8. FIG. 8A describes the operation of the first reflector 8, and FIG. 8B shows projection using the first reflector 8.

The screen apparatus 1 is so structured that the first reflector 8 is used to perform projection when the near-distance reflection area A3, which is preferable for near-distance (about 20 cm) projection, is displayed as the reflection surface, as shown in FIG. 8B. The first reflector 8 reflects and projects the projection light Lp from the projector PJ on the screen 2. In this case, the distance indicator B may display “Mirror.”

The base 6 has a surface portion 6B recessed from the upper surface 6A and formed in an area that is located in the vicinity of the lower winder 3 but does not interfere with the drive unit 7. The first reflector 8 is provided on the surface portion 6B. The first reflector 8 includes a reflection mirror 81, a frame 82 that holds the reflection mirror 81, and a support shaft 83 that rotates and foldably supports the frame 82.

When the near-distance reflection area A3 is displayed as the reflection surface of the screen 2, a user grasps the frame 82 of the first reflector 8 and rotates the first reflector 8 folded on the surface portion 6B around the support shaft 83 to a predetermined position, as shown in FIG. 8A. The projector PJ is then so installed in a predetermined position (not shown) on the surface portion 6B that the projection lens P1 of the projector PJ faces the reflection mirror 81, as shown in FIG. 8B. The projection light Lp is then projected from the projector PJ, reflected off the reflection mirror 81, and projected on the reflection area A3. In the thus configured screen apparatus 1, the projection light Lp is reflected off the reflection mirror 81 toward the viewer without any decrease in contrast. When the first reflector 8 is not in use, the frame 82 is rotated, folded on the surface portion 6B, and accommodated there, as indicted by the chain double-dashed line in FIG. 8A.

Using the thus configured first reflector 8 provides the following advantageous effects: According to the reflective screen apparatus 1 of the present variation, which includes the first reflector 8 that reflects and projects the projection light Lp on the reflection surface, the projector PJ can be preferably installed in the vicinity of the reflective screen 2 in a more preferable manner. Further, since the first reflector 8, which is foldably disposed, is folded not to interfere with anything when the first reflector 8 is not in use, the convenience provided by the reflective screen apparatus 1 can be maintained and improved.

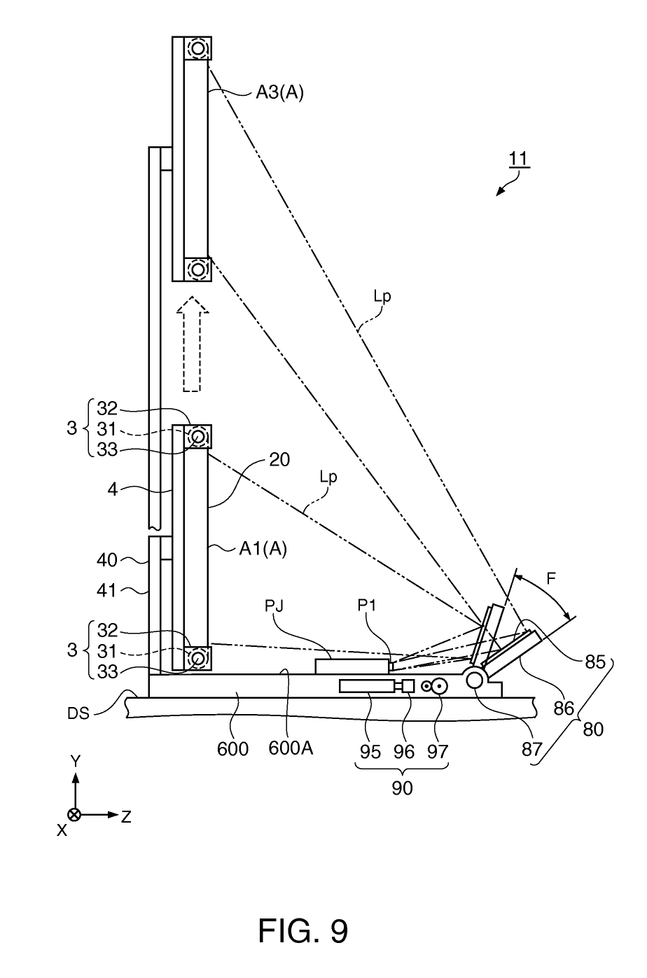

In the reflective screen apparatus 10 of the second embodiment described above, the projection lens P1 of the projector PJ faces the reflection surface for projection in correspondence with the projection angle E, but the reflective screen apparatus 10 is not necessarily configured this way. Alternatively, a second reflector 80 that changes the angle of reflection F (FIG. 9) may be used to reflect and project the projection light Lp on the reflection surface in correspondence with the variable projection angle E. In the following section, a concise description will be made on the configuration and operation of a reflective screen apparatus 11 using the second reflector 80 and how the reflective screen apparatus 11 performs projection.

FIG. 9 is a side view showing a variation of the second embodiment using the second reflector 80. FIG. 9 simultaneously shows a case where A1 is displayed and a case where A3 is displayed as the reflection area A of the screen 20.

The reflective screen apparatus 11 includes the second reflector 80 in place of the mount 50 in the reflective screen apparatus 10 of the second embodiment, as shown in FIG. 9. The base 60 and the drive unit 70 in the second embodiment are replaced with a base 600 and a drive unit 90, which slightly differ therefrom in accordance with the replacement of the mount 50 by the second reflector 80. The other components are substantially the same as those in the second embodiment.

The second reflector 80 is disposed on an upper surface 600A of the base 600. The second reflector 80 includes a reflection mirror 85, a frame 86 that holds the reflection mirror 85, and a support shaft 87 that changes the angle of the frame 86 as the angle of reflection F corresponding to the projection angle E (see FIG. 5) and supports the frame 86. The angle of reflection F corresponding to the projection angle E may be exposed (displayed) in the angle indicator C in the second embodiment.

The drive unit 90, when driven by the rotation of the winders 3, expands/contracts the expander/contractor 40 to move the screen 20 (including winders 3 and holder 4) to a height corresponding to the reflection area A as in the second embodiment and rotate the second reflector 80 to an appropriate angle of reflection F. The drive unit 90 is disposed in the base 600. The drive unit 90 includes a motor 95 rotatable in forward and backward directions, a transfer gear 96 disposed in association with the motor 95, and a reduction gear train 97 that engages with the transfer gear 96 and engages with the support shaft 87 of the second reflector 80. The support shaft 87 of the second reflector 80, which engages with a final gear of the reduction gear train 97, rotates the frame 86 (reflection mirror 85), which reflects the projection light Lp from the projector PJ.

Using the thus configured second reflector 80 provides the following advantageous effects: According to the reflective screen apparatus 11 of the present variation, which includes the second reflector 80 that reflects and projects the projection light Lp on the reflection surface, the projector PJ can be preferably installed in the vicinity of the reflective screen 20, whereby the convenience provided by the reflective screen apparatus 11 is improved. Further, providing the drive unit 90 allows the second reflector 80 to readily rotate to a predetermined angle of reflection F, whereby the convenience provided by the reflective screen apparatus 11 is further improved.

Variations other than those using the first reflector 8 and the second reflector 80 described above will be described below.

The reflective screen apparatus 1 according to the first embodiment described above, which includes the drive unit 7, may alternatively not include the drive unit 7. In this case, since the distance indicator B that exposes (displays) the projection distance D from the projector PJ is provided, the position where the projector PJ is installed (projection distance D) relative to the reflective screen 2 whose reflection surface is moved by the rotation of the winders 3 can be presented, whereby the mount 5 can be manually moved and the projector PJ can be installed in a projection position corresponding to the reflection surface for appropriate projection. In this way, the projector PJ can be installed in an appropriate projection position in correspondence with a desired reflection surface, whereby the projection light Lp can be efficiently reflected.

The reflective screen apparatus 10 according to the second embodiment described above, which includes the drive unit 70, may alternatively not include the drive unit 70. In this case, since the angle indicator C that exposes (displays) the projection angle E of the projector PJ is provided, the expander/contractor 40 is used to move the reflective screen 20 whose reflection surface is moved by the operation of the winders 3 to a height corresponding to the displayed reflection surface. Since the angle at which the projector PJ is installed (projection angle E) can be presented, the mount 50 can be manually rotated and the projector PJ can be installed at a projection angle corresponding to the reflection surface. In this way, the reflective screen 20 can be moved to an appropriated height in correspondence with a desired reflection surface, whereby the projector PJ can be installed at an appropriate projection angle E and the projection light Lp can be efficiently reflected.

In the reflective screen apparatus 1 according to the first embodiment described above, the distance indicator B, which is disposed in a right area of the front surface 21A of the reflective screen 2, may alternatively be disposed in a left area thereof. Further, the dials 33 of the winders 3, which are disposed on the left side, may alternatively be disposed on the right side. The same holds true for the angle indicator C and the dials 33 in the second embodiment.

In the reflective screen apparatus 10 according to the second embodiment described above, driven by the rotation of the winders 3, the expander/contractor 40 expands/contracts and the mount 50 is rotated to a predetermined projection angle E. The reflective screen apparatus 10 is not necessarily configured this way, and when the expander/contractor 40 is expanded/contracted, the winders 3 may be driven and rotated to display a reflection surface corresponding to a predetermined height and the mount 50 may be rotated to a predetermined projection angle E. The convenience provided by the reflective screen apparatus 10 is therefore improved.

In the reflective screen apparatus 1 according to the first embodiment described above, the mount 5 is driven by the rotation of the winders 3 and moved to a position at a corresponding projection distance D. The reflective screen apparatus 1 is not necessarily configured this way, and the mount 5 may alternatively be moved to a desired position (projection distance D). In this case, the winders 3 are driven and rotated to display a reflection surface corresponding to the position to which the mount 5 has been moved (projection distance D). The convenience provided by the reflective screen apparatus 1 is therefore improved.

In the reflective screen apparatus 10 according to the second embodiment described above, driven by the rotation of the winders 3, the expander/contractor 40 expands/contracts and the mount 50 is rotated to a predetermined projection angle E. The reflective screen apparatus 10 is not necessarily configured this way, and when the mount 50 is rotated to a desired projection angle E, the expander/contractor 40 is driven and expands/contracts to move the reflective screen 20 to a height corresponding to the projection angle E and the winders 3 are driven and rotated to display a reflection surface corresponding to the projection angle E. The convenience provided by the reflective screen apparatus 10 is therefore improved.

The reflection films 23 in the reflective screen apparatus 1 according to the first embodiment described above are selectively formed on the inner surfaces 22A of the plurality of recesses 22. The reflection films are not necessarily formed this way and may alternatively be selectively formed on the outer surfaces of a plurality of protrusions. The same holds true for the second embodiment.

The reflective screen apparatus 1 according to the first embodiment described above is used with a compact projector PJ having a plan-view size of about a postcard. The reflective screen apparatus 1 is not necessarily used this way and can be used with a projector having an ordinary size. The same holds true for the second embodiment.

The entire disclosure of Japanese Patent Application No. 2011-232550, filed Oct. 24, 2011 is expressly incorporated by reference herein.

What is claimed is:

1. A reflective screen apparatus comprising:
a reflective screen having a reflection surface that reflects projection light off reflectors selectively formed on a screen substrate in accordance with the angle of incidence of the projection light; and
a pair of winders that support respective ends of the reflective screen and rotate in forward and backward directions to wind and release the reflective screen,
wherein the winders drive each other and operate in opposite ways to move the reflection surface between the winders.

2. The reflective screen apparatus according to claim 1, further comprising
a distance indicator that exposes a projection distance that corresponds to the reflection surface and is associated with a projector that outputs the projection light.

3. The reflective screen apparatus according to claim 2,
wherein the distance indicator is formed on the screen substrate.

4. The reflective screen apparatus according to claim 1, further comprising:
a holder that holds the winders;
amount on which a projector that outputs the projection light is mounted; and
a base that supports the holder and the mount.

5. The reflective screen apparatus according to claim 4, further comprising
a drive unit that is driven by the rotation of the winders to move the mount to a predetermined position corresponding to the projection distance.

6. The reflective screen apparatus according to claim 4, further comprising
a first reflector that reflects and projects the projection light on the reflection surface.

7. The reflective screen apparatus according to claim 6,
wherein the first reflector is foldably disposed.

8. The reflective screen apparatus according to claim 1, further comprising
an angle indicator that exposes a projection angle that corresponds to the reflection surface and is associated with a projector that outputs the projection light.

9. The reflective screen apparatus according to claim 8,
wherein the angle indicator is formed on the screen substrate.

10. The reflective screen apparatus according to claim 1, further comprising:
a holder that holds the winders;
an expander/contractor that moves the holder to a predetermined height;
amount on which a projector that outputs the projection light is mounted and which changes a projection angle of the projector; and
a base that supports the expander/contractor and the mount.

11. The reflective screen apparatus according to claim 10, further comprising
a drive unit that is driven by the rotation of the winders or the expansion/contraction of the expander/contractor to not only expand/contract the expander/contractor or rotate the winders but also rotate the mount to a predetermined position corresponding to the projection angle.

12. The reflective screen apparatus according to claim 1, further comprising:
a holder that holds the winders;
an expander/contractor that moves the holder to a predetermined height;
a second reflector that changes the angle of reflection in correspondence with the projection angle to reflect and project the projection light on the reflection surface; and
a base that supports the expander/contractor.

13. The reflective screen apparatus according to claim 12, further comprising
a drive unit that is driven by the rotation of the winders or the expansion/contraction of the expander/contractor to not only expand/contract the expander/contractor or rotate the winders but also rotate the second reflector to a predetermined position corresponding to the angle of reflection.

14. The reflective screen apparatus according to claim 8, further comprising:
a holder that holds the winders;
an expander/contractor that moves the holder to a predetermined height;
amount on which a projector that outputs the projection light is mounted and which changes a projection angle of the projector; and
a base that supports the expander/contractor and the mount.

15. The reflective screen apparatus according to claim 8, further comprising:
a holder that holds the winders;
an expander/contractor that moves the holder to a predetermined height;
a second reflector that changes the angle of reflection in correspondence with the projection angle to reflect and project the projection light on the reflection surface; and
a base that supports the expander/contractor.
